(19) United States
(12) Patent Application Publication
(10) Pub. No.: US 2016/0214548 A1
(43) Pub. Date: Jul. 28, 2016

(54) MULTILAYER STRUCTURAL COMPONENT, METHOD FOR THE PRODUCTION THEREOF AND USE THEREOF

(71) Applicant: COVESTRO DEUTSCHLAND AG, Leverkusen (DE)

(72) Inventors: Philipp MÖLLER, Köln (DE); Ulrich GROSSER, Kürten (DE); Thomas GRIMM, Pulheim (DE); Rolf ALBACH, Köln (DE); Roland BRAMBRINK, Leichlingen (DE); Bernd BREUER, Leverkusen (DE)

(21) Appl. No.: 15/023,763

(22) PCT Filed: Sep. 23, 2014
(86) PCT No.: PCT/EP2014/070172

§ 371 Date: Mar. 22, 2016

(30) Foreign Application Priority Data
Sep. 27, 2013 (EP) 13186386.2
Sep. 30, 2013 (EP) 13186695.6

(51) Int. Cl. B60R 13/02; B29B 11/06; B29C 44/12; B29B 11/04

(52) U.S. Cl. CPC B60R 13/0206; B29B 11/04; B29B 11/06; B29C 44/1271; B29C 44/1233; B29K 2715/00; B29K 2105/20

(57) ABSTRACT

The invention relates to a multilayer structural component (84, 110, 120, 170) comprising a first and a second fibre-composite layer (102, 104, 122, 124, 172, 174) and a foam layer (106, 126, 176), arranged in between, made of foamed plastics material, wherein the first and the second fibre-composite layer (102, 104, 122, 124, 172, 174) each have at least one fibrous layer (4, 16, 18, 24) made of a fibre material, said fibrous layer being embedded in a thermoplastic-based matrix (8, 20). The structural component has an anchoring structure (140) for attaching to a force introduction element. The invention furthermore relates to a method for producing a structural component (84, 110, 120, 170), in which a first and a second fibre-composite sheet (2, 12, 48, 52) are provided, wherein the first and the second fibre-composite sheet (2, 12, 48, 52) each have at least one fibrous layer (4, 16, 18, 24) made of a fibre material, said fibrous layer being embedded in a thermoplastic-based matrix (8, 20), in which the first fibre-composite sheet (2, 12, 48, 52) is thermoformed to form a first fibre-composite semifinished product (64, 86, 88) and the second fibre-composite sheet (2, 12, 48, 52) is thermoformed to form a second fibre-composite semifinished product (64, 86, 88), in which the first and the second fibre-composite semifinished product (64, 86, 88) are arranged in a foaming mould (90) such that a cavity (96); is formed between the first and the second fibre-composite semifinished product (64, 86, 88), and in which the cavity (96) is foamed by injection of a foaming plastics material. Furthermore, the anchoring structure (140) is integrated into the structural component.

The invention relates to multilayer structural components, in particular for the use as lightweight component.

In automobile construction, and also in other industrial sectors, there has for sometime been increased use of lightweight components, the aim of this being to achieve advantages by way of example in relation to fuel consumption. In particular in automobile construction there is a requirement for structural components which firstly have low weight and secondly can comply with the safety requirements and stability requirements applicable to automobile construction, for example in relation to strength. There is also a particular further requirement, aimed at increasing travel comfort in automobiles, for structural components with insulation properties or intrinsic frequency spectra contributing to achievement of a low noise level in the vehicle interior. The automobile industry moreover in particular imposes stringent requirements on the optical properties and surface qualities in particular of visible structural components, so that the structural components allow by way of example a uniform coating layer.

The prior art discloses various types of lightweight components. Among these are in particular components made of a combination of metallic sheets with supportive structures, for example made of plastics materials, these being entirely or to some extent bonded to one another by means of adhesive bonding. Other known products are moreover injection-molded components with a metallic supportive structure, injection-molded components per se, and thermoset FRP parts (RTM, SMC, BMC), optionally with glassfiber reinforcement or with carbon-fiber reinforcement.

“Resin Transfer Molding” (RIM)—often also termed transfer molding—is a process for the production of fiber-reinforced components where fiber mats are inserted into a mold and then a liquid resin-hardener mixture is cast around same under pressure. The resin reacts when heated, giving a solid product.

“Sheet Molding Compound” (SMC) is a term used for press compositions known from the prior art in the form of sheets of dough-like consistency made of reactive thermoset resins and glass fibers and used for the production of fiber-plastic composites. The SMCs comprise all of the necessary components in fully premixed form, ready for processing. Polyester resins or vinyl ester resins are generally used. The reinforcement fibers take the forni of mats, or less frequently of woven fabric, a typical fiber length in these being from 25 to 50 mm.

“Bulk Molding Compound” (BMC) is a known semifinished fiber-matrix product. It is mostly composed of short glass fibers and a polyester resin or vinyl ester resin, and other reinforcing fibers or resin systems are also possible here. Natural fibers are increasingly widely used as low-cost alternative to glass fibers. BMC is supplied as unshaped composition in bags or other packs.

However, notwithstanding these known lightweight components there continues to be a requirement for improved lightweight components, since the known systems either have inadequate properties, in particular in relation to stability, stiffness, etc. or demand very complicated methods of production or use, since by way of example they require separate production of metal components and plastics components which then have to be bonded together in a separate operation during the assembly of the vehicle, for example by adhesive-bonding of a plastics sheet to a supportive structure made of metal.

Another problem with the lightweight components known hitherto from the prior art is moreover combination with force-introducing functional elements (force-introducing elements). By way of example cladding has hitherto been produced by combining metal supportive structures or metal frame structures, intended to absorb loads, with external parts such as metal sheets or plastics sheets. The term spaceframe is used in the automobile sector for structures of this type. In contrast, in another known type of design, self-supporting structures, the exterior bodywork parts absorb loads. In previous approaches to solutions, force-introducing elements intended to dissipate loads are in principle bonded to load-bearing frame structures, in particular by welding, screw connections, or riveting, with resultant increased operating cost.

There is therefore in particular also a requirement for lightweight components into which force-introducing elements can be integrated without any need to use the abovementioned fastening methods, thus allowing simplified attachment of force-introducing elements.

Starting from the above prior art, it is an object of the present invention to provide a structural component which is intended for lightweight construction and which firstly has good properties such as stiffness and strength, with low weight, and secondly is relatively easy to produce and to use, in particular as finished component for direct use in motor vehicles.

This object is at least to some extent achieved in the invention via a multilayer structural component which comprises a first and second fiber-composite layer and, arranged therebetween, a foam layer made of foamed plastic, where the first and the second fiber-composite layer respectively have at least one fiber ply which is made of a fiber material and which has been embedded into a matrix based on a thermoplastic. The term “composite sheet” is also used for this type of fiber-composite layer with at least one fiber ply which is made of a fiber material and which has been embedded into a matrix based on a thermoplastic. The matrix based on a plastic preferably comprises at least one first and one second plastics layer, with the fiber ply arranged therebetween. The plastics layers can by way of example respectively have been produced by using at least one ply of plastics foil. Structural components of the invention moreover have an anchoring structure with a base for linkage to a force-introducing element, and with a branching structure, where the branching structure comprises at least three branches extending from the base in various directions.

The invention recognizes that by virtue of the combination of two composite sheets with, arranged therebetween, a foam layer made of foamed plastic it is possible to provide a structural component which has very good mechanical properties, in particular in relation to stiffness and stability, together with low weight, and which is accordingly in particular suitable as lightweight component for automobile construction. These properties are moreover provided in an integral component which can be installed directly at the intended location of use, e.g. within a motor vehicle. In particular the structural components require no additional frame structures, since they themselves have high intrinsic stiffness, and can therefore absorb large forces without excessive defoitnation.

With the structural component described it is moreover also possible to achieve good acoustic insulation properties and to adjust the intrinsic frequency spectrum to be appropriate to the respective requirements. In particular by virtue of the inultilayer, sandwich-like structure of the structural component it is possible to achieve deflection of sound waves, and by virtue of the various densities of the fiber-composite layers and of the foam layer it is possible to achieve better acoustic insulation than is possible by way of example in the case of aluminum sheet or steel sheet. Aluminum sheet or steel sheet here requires additional insulation, for example achieved by additional reverse-coating with PU foam, whereas the structural component described itself achieves the required insulation, and there is no need to use additional materials and operations for insulation.

The first and the second fiber-composite layer can have identical or different structure, for example in respect of the type of fiber, the number of fiber plies, and the type of thermoplastic. Warpage of the structural component can be prevented by using identical structure of the first and second fiber-composite layer. On the other hand, a structural component with properties adjusted to be appropriate for a particular use can be produced by using first and second fiber-composite layers of different types.

The object described above is moreover at least to some extent achieved in the invention via a process for the production of a structural component, in particular of a structural component described above, where a first and a second fiber-composite sheet are provided, where the first and the second fiber-composite sheet respectively have at least one fiber ply which is made of a fiber material and which has been embedded into a matrix based on a thermoplastic, where the first fiber-composite sheet is thermoformed to give a first semifinished fiber-composite product and the second fiber-composite sheet is thermoformed to give a second semifinished fiber-composite product, where the first and the second semifinished fiber-composite product are arranged in a foaming mold in such a way that, between the first and the second semifinished fiber-composite product, a cavity is formed, and where a foaming plastic is injected to form a foam in the cavity. The anchoring structure is arranged in an accommodation space introduced into the first or the second semifinished fiber-composite product in such a way that the anchoring structure protrudes into the cavity and, when foam is introduced into the cavity, is embedded there by the foamed plastic.

The expression “thermoforming of a fiber-composite sheet” means that the fiber-composite sheet is firstly heated to a temperature above the softening point of the thermoplastic and then, in particular with use of a forming mold, is subjected to a forming process. The temperature of the forming mold can likewise have been controlled for this purpose, for example at a temperature in the region of the softening point of the thermoplastic, for example in the range of +/−20° C. around the softening point. The first and the second semifinished fiber-composite product can have the same shape or different shapes. It is preferable that the fiber-composite sheet is heated to a temperature of at least 80° C., with preference at least 90° C., in particular at least 100° C. This avoids a situation where, after heating, the fiber-composite sheet solidifies too rapidly and then can no longer be correctly thermoformed, or where there may even be local degradation of the plastics matrix. When polycarbonates are used for the matrix it is preferable that the fiber-composite sheet is heated to a temperature in the region of 100° C.

The composite element can be produced in various ways, these being by way of example also known from the production of instrument panels or roof linings. The temperature-controlled mold preferably required for this purpose has a first mold half corresponding in essence to the shape of the first semifinished fiber-composite product and a second mold half corresponding in essence to the shape of the second semifinished fiber-composite product; the respective semifinished fiber-composite product is fixed thereto.

In one process, the semifinished fiber-composite products are provided, in their entirety or to some extent, with adhesive, a layer of thermoformable, preferably thermoset, foam is inserted, and the mold is closed and subjected to pressure at a suitable temperature.

In another process, a layer of thermoformable, preferably thermoset, foam provided, in its entirety or to some extent, with adhesive is inserted, and the mold is closed and subjected to pressure at a suitable temperature.

In another process, a foamable plastic or a reactive mixture is applied to a semifinished fiber-composite product, the mold is almost closed, and the reactive mixture foams between the semifinished fiber-composite products, and it is preferable here that the mold is further closed when the foaming mixture approaches the apertures remaining after closure of the mold and threatens to escape from the mold. However, there are also other known methods for preventing the escape of foam, e.g. labyrinths and open-cell foam foils. However, in accordance with the design of the finished part a small extent of escape of foam can also be acceptable if the complete closure of the mold would be too complicated or would lead to inadequate quality of the finished part.

In another process, the mold with the two semifinished fiber-composite products is first substantially closed, a reactive mixture is then introduced into the resultant cavity, and the foamable plastic or the reactive mixture foams between the semifinished fiber-composite products, and it is preferable here that the mold is further closed when the foaming mixture approaches the apertures remaining after closure of the mold and threatens to escape from the mold. However, there are also other known methods for preventing the escape of foam, e.g. labyrinths and open-cell foam foils.

In another process, two semifinished fiber-composite products are first connected, with or without fixing, and then inserted into a mold, the latter is substantially closed, and then a reactive mixture is introduced into the cavity, and the foamable plastic or the reactive mixture foams between the semifinished fiber-composite products, and it is preferable here that the mold is further closed when the foaming mixture approaches the apertures remaining after closure of the mold and threatens to escape from the mold. However, there are also other known methods for preventing the escape of foam, e.g. labyrinths and open-cell foam foils.

However, in accordance with the design of the finished part a small extent of escape of foam can also be acceptable if the complete closure of the mold would be too complicated or would lead to inadequate quality of the finished part.

The object described above is moreover achieved with use of a structural component described above for the production of a vehicle bodywork component, in particular of a tailgate, an engine hood, or a roof element.

By virtue of their structural mechanical properties and low weight, the structural components are particularly suitable for vehicle bodywork components. In particular high surface quality moreover permits use of these structural components for horizontally arranged components such as tailgates, engine hoods, or roof elements which because of their large surface area and exposed position have to have particularly high surface quality.

The structural component described is moreover in particular suitable as vehicle bodywork component because it combines mechanical properties with individually adjustable surface characteristics, and there is therefore no requirement for subsequent combination with reinforcing aids or surface elements, as is the case by way of example when traditional spaceframe design is used.

Various embodiments of the structural component, of the process for the production of a structural component, and of the use of a structural component are described below. Even where the embodiments are to some extent described specifically only for the structural component, the process, or the use, they respectively apply correspondingly to the structural component, to the process, and to the use.

The matrix of the fiber-composite layer is preferably a thermoplastic. Suitable thermoplastics are polycarbonate, polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), cyclic polyolefin, poly- or copolyacrylates, and poly- or copolymethacrylate, e.g. poly- or eopolymethyl methacrylates (such as PMMA), polyamides (preferably polyamide 6 (PA6) and polyamide 6,6 (PA6,6)), and also copolymers with styrene, e.g. transparent polystyrene-acrylonitrile (PSAN), thermoplastic polyurethanes, polymers based on cyclic olefins (e.g. TOPAS®, a product commercially available from Ticona), and mixtures of the polymers mentioned, and also polycarbonate blends with olefinic copolymers or graft polymers, for example styrene/acrylonitrile copolymers, and optionally other abovementioned polymers.

Preferred thermoplastics are selected from at least one from the group of polycarbonate, polyamide (preferably PA6 and PA6,6) and polyalkyl acrylate (preferably polymethyl methacrylate), and also mixtures of these thermoplastics with, for example, polyalkylene terephthalates (preferably polybutylene terephthalate), with impact modifiers such as acrylate rubbers, with ABS rubbers or with styrene/acrylonitrile copolymers. The thermoplastics generally comprise conventional additives such as mold-release agents, heat stabilizers, UV absorbers.

Preferred thermoplastics are polycarbonates (homo- or copolycarbonates) and also mixtures of polycarbonates with polyalkylene terephthalate (in particular with polybutylene terephthalate). The proportion of the polyalkylene terephthalate is generally from 5 to 95% by weight, preferably from 10 to 70% by weight, in particular from 30 to 60% by weight, based on the entire composition, and preference is further given to mixtures of the polycarbonates or polycarbonate/polyalkylene terephthalate blends with ABS copolymers and/or SAN copolymers. Preferred thermoplastics are those composed of polycarbonates and mixtures of polycarbonates with polymers selected from at least one from the group of the polyalkylene terephthalates, in particular polybutylene terephthalate (as described above), and also ABS rubbers and acrylate rubbers, optionally with styrene/acrylonitrile copolymers.

For the purposes of the present invention, polycarbonates are not only homopolycarbonates but also copolycarbonates and polyester carbonates, as described by way of example in EP-A 1,657,281.

Aromatic polycarbonates are produced by way of example by reaction of diphenols with carbonyl halides, preferably phosgene and/or with aromatic diacyl dihalides, preferably dihalides of benzenedicarboxylic acids, in the interfacial process, optionally with use of chain terminators, for example monophenols, and optionally with use of trifunctional or more than trifunctional branching agents, for example triphenols or tetraphenols. Production by way of a melt-polymerization process by reaction of diphenols with, for example diphenyl carbonate is likewise possible.

The polycarbonates preferably to be used are in principle produced in a known manner from diphenols, carbonic acid derivatives, and optionally branching agents.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxybiphenyl sulfide, 4,4′-dihydroxybiphenyl sulfone, and also di- and tetrabrominated or chlorinated derivatives of these, for example 2,2-bis(3-chloro-4-hydroxyphenyl)propane, 2,2-bis(3,5-dichloro-4-hydroxyphenyl)propane, and 2,2-bis(3,5-dibromo-4-hydroxyphenyl)propane. Preference is in particular given to 2,2-bis(4-hydroxyphenyl)propane (bisphenol A).

The biphenols can be used individually or in the form of any desired mixtures. The biphenols are known from the literature or can be obtained by processes known from the literature.

The average molar masses of the thermoplastic, aromatic polycarbonates, weight average Mw, measured by GPC (gel permeation chromatography with polycarbonate standard) are from 15 000 to 50 000 g/mol, preferably from 20 000 to 40 000 g/mol, particularly preferably from 26 000 to 35 000 g/mol.

The matrix of the fiber-composite material is preferably a thermoplastic functioning as thermoplastic binder between the fibers. The fiber composite of the fiber-composite layer′ generally comprises from 20 to 70% by volume, preferably from 30 to 55% by volume, particularly preferably from 35 to 50% by volume, of fibers, based on the finished composite sheet.

The foam used for the filling of the composite element can have predominantly open cells or predominantly closed cells, and can comprise a very wide variety of foams. The foaming process can use chemical or physical blowing agents. Suitable polymers for the production of core layers of this type can be isocyanate-based (polyurethane, polyurea, polyisocyanurate, polyoxazolidinone, polycarbodiimide), epoxy-based, phenol-based, melarnine-based, PVC, polyimide, polyamide, or a mixture of the polymers mentioned, preference being given here to thermosets and particular preference being given here to isocyanate-based thermosets and mixtures of these. Suitable polyurethanes are based on short-chain poly-ether polyols with equivalent weight from 60 to 400 g/mol, or on long-chain polyether polyols with equivalent weight from 400 to 3000 g/mol.

The foams mentioned are preferably stable above the softening point of the polymer used in the semifinished fiber-composite products, the temperature regarded as stability limit being that at which the coefficient of thermal expansion alpha of the foam, measured using the measurement parameters of ASTM E831 (Campus), becomes less than zero.

With the structural component described above it is possible to achieve high surface quality which by way of example allows uniform coating of the structural component and thus use in particularly exposed regions, for example in the bodywork of a motor vehicle.

When fiber-composite materials are produced with a fiber material and, embedding the fiber material, a matrix based on thermoplastics, the materials exhibit different shrinkages during cooling. Whereas fiber materials typically exhibit only very little shrinkage, or in the case of carbon fibers actually negative shrinkage, thermoplastics exhibit higher shrinkage. Since the concentration of the fibers varies locally within the matrix there are consequently, dependent on the position of the fibers, regions with more matrix material and regions with less matrix material, and shrinkage therefore varies accordingly. The fiber-composite material can thus have a non-uniform surface affected by the fiber structure of the material. The polycarbonates, in particular amorphous polycarbonates, used for the matrix of the fiber-composite layers in the structural component embodiment described above exhibit about 50% lower shrinkage values than other, in particular semicrystalline, plastics, thus permitting avoidance of surface effects due to the fibers.

In another embodiment of the structural component, the fiber ply of the first and/or of the second fiber-composite layer takes the form of unidirectional fiber ply, of woven-fabric ply, of random-fiber ply, or of a combination thereof. It is preferable to use unidirectional fiber plies, since with these it is possible to achieve better surface quality. Unidirectional fiber plies are sometimes also termed unidirectional (UD) tapes, and are laid fiber screens where the fibers lie alongside one another in one direction. The surface of unidirectional fiber plies is therefore smoother than is the case by way of example with woven-fabric plies, and it is thus also possible to achieve a smoother surface of the first and/or second fiber-composite layer, and thus of the structural component. It is moreover possible to adapt the direction of the fibers of a unidirectional fiber ply to be appropriate to the main direction of loading of the structural component, thus permitting specific reinforcement of the structural component for its intended use.

In another embodiment of the structural component, the fiber material of the first and/or of the second fiber-composite layer comprises fibers made of one or more of the following fiber types: glass fibers, carbon fibers, basalt fibers, aramid fibers and metallic fibers. These fibers are particularly preferred to natural fibers because they can withstand the high temperatures during the production of the fiber-composite sheets and of the structural components. If polycarbonates are used for the matrix of the fiber-composite layers the best results are provided in particular by glass fibers and carbon fibers.

In another embodiment of the structural component, the content by volume of the fiber material of the first and/or of the second fiber-composite layer based on the total volume of the respective fiber-composite layer is in the range from 30 to 60% by volume, preferably in the range from 40 to 55% by volume. At higher contents by volume of the fiber material the fiber-composite layer comprises overall too little matrix material, and adequate consolidation of the fibers, i.e. microimpregnation, is not achieved. Only when a fiber has been embedded by the plastic of the matrix does it become durable and contribute to the stiffness of the entire component. At fiber contents of at most 60% by volume or at most 55% by volume it is possible to achieve embedment of a large proportion, in particular in essence all, of the individual fibers by the plastic of the matrix, and thus to achieve high stiffness of the structural component. When proportions of plastic are too high, in particular when the content of the fiber material by volume is smaller than 30% by volume or 40% by volume, the corresponding fiber-composite layer, and therefore the structural component, merely becomes thicker and heavier, without any corresponding improvement in mechanical properties.

The thermoplastic of the first and/or second fiber-composite layer preferably has a softening point of at least 120° C., preferably at least 130° C. It is thus possible to provide a structural component that retains dimensional stability even at high temperatures that may occur in an intended application, for example above 100° C., preferably above 110° C.

In another embodiment of the structural component, the breakdown temperature of the foamed plastic of the foam layer is at least 130° C., preferably at least 160° C., in particular above 180° C. The expression “breakdown temperature of the foaming plastic” means the temperature at which the foam structure of the foam layer formed by the foaming plastic undergoes breakdown due to shrinkage processes. Shrinkage processes are characterized in that the coefficient of linear expansion of the foam is negative. The breakdown process is therefore studied by determining linear expansion by a method based on ASTM E831 (Campus) in the temperature range from 273 K upwards. Use, for the foam layer, of a plastic with breakdown temperature at or above the preferred softening point of the composite sheet provides a structural component that is entirely dimensionally stable even at high temperatures. This approach moreover also facilitates subsequent thermoforming of the structural component, since at the temperatures required for subjecting the fiber-composite layers to the forming process the foam structure does not become too soft, and therefore any distortion of the structural component that could otherwise be caused is avoided. The breakdown temperature of the foamed plastic is preferably above the softening point of the plastic used for the matrix of the first and/or second fiber-composite layer, and specifically in particular by at least 20° C., preferably by at least 40° C.

In a more preferred embodiment, the foam layer is a thermoset foam layer. When a thermoset foam layer is compared to the thermoplastics for the first and/or second fiber-composite layer, it typically retains dimensional stability at higher temperatures, for example up to 180° C.

A relatively high breakdown temperature of the foamed plastic of the foam layer moreover prevents breakdown of the foam layer during subsequent softening of the first or second fiber-composite layer, for example for welding to another component, and therefore prevents undesired deformation or breakdown of the structural component.

In another embodiment of the structural component, the plastic of the foam layer comprises one or more plastics from the following group: suitable polymers for the production of core layers of this type can be isocyanate-based (polyurethane, polyurea, polyisocyanurate, polyoxazolidinone, polycarbodiimide), epoxy-based, phenol-based, melamine-based, PVC, polyimide, polyamide, or a mixture of the polymers mentioned, preference being given here to thermosets, and particular preference being given here to isocyanate-based thermosets and mixtures of these. Other suitable foamable polymers are polycarbonates and polyolefins. An example of a reason for very good suitability of polyurethanes for the foam layer is that they firstly adhere well on the fiber-composite layers and thus provide stable bonding of the multilayer structural component, and secondly typically have a high breakdown temperature in the region of about 150 to 160° C., thus permitting production of structural components that are dimensionally stable even at high temperatures.

In another embodiment of the structural component, the foamed plastic of the foam layer has a density in the range of 80 to 150 g/cm³, preferably from 85 to 130 g/cm³, particularly preferably from 90 to 120 g/cm³. This approach firstly achieves good acoustic insulation properties, adequately high strength values, and also good thermal insulation properties, and secondly achieves low weight of the structural component.

In another embodiment of the structural component, the foam layer has at least two subregions with different thicknesses. The three-dimensional shape of the structural component described above can be adapted very flexibly to be appropriate to the respective intended use. In particular, the external geometry of the structural component can be adapted to be appropriate to the respective use via provision of a foam layer with regions of different thickness. In particular, the structural component can have sections where the first and the second fiber-composite layer are not parallel, but instead are at an angle of more than 0°, for example of more than 5°, to one another, in such a way that the structural component comprises a region with gradually changing thickness. It is preferable that the local thickness of the structural component is adapted to be appropriate to the mechanical loads in the planned use of the structural component. By way of example, a structural component for use in a trunk lid can be designed to be locally thicker in the region of the hinges and locally thinner in regions subject to less loading.

In another embodiment of the structural component, the first and/or the second fiber-composite layer has a thickness in the range from 0.2 to 6.0 mm, preferably from 0.4 to 4.0 mm, in particular from 0.8 to 1.5 mm. In particular, a thickness in the range from 0.8 to 1.5 mm could achieve good mechanical properties in respect of stiffness. A layer thickness below 0.8 mm reduces stiffness, while a thickness above 1.5 mm can achieve very stiff components, but with correspondingly high weight. However, thicknesses of up to 4 mm, up to 5 mm, or up to 6 mm are also conceivable for structural components requiring particularly stable design, for example for an engine hood. Lower layer thicknesses are moreover also conceivable for very small components, in particular starting at 0.4 mm or indeed starting at 0.2 mm. The first and the second fiber-composite layer can in principle have the same thickness or different thicknesses.

In another embodiment of the structural component, the foam layer has a maximal thickness in the range from 2 to 80 mm, preferably from 8 to 25 mm. The expression “maximal thickness” here means the maximal distance between the first and the second fiber-composite layer, the foam layer having been arranged between these. It is not necessary that the foam layer has a constant thickness, and the thickness range in the present embodiment is therefore based on the maximal thickness of the foam layer.

Particularly good stiffness properties are achieved in the range from 8 to 25 mm. Thicknesses below 8 mm reduce stiffness and moreover incur higher production costs, since the injection process to form a foam layer of less than 8 mm is difficult, or at least is more difficult. Thicknesses of more than 25 mm achieve very stiff components, but at the cost of higher weight, thus reducing the advantage of the lightweight construction of the structural component. However, greater thicknesses of the foam layer, in particular thicknesses up to 80 mm, are also conceivable in certain applications where by way of example very good insulation is important.

In another embodiment of the structural component a plastics foil, in particular a polycarbonate foil, has been applied on that side of the first and/or the second fiber-composite layer that faces away from the foam layer. Application of an additional foil onto at least one of the fiber-composite layers of the structural component can achieve improved surface quality of the structural component. In particular it is possible, even under high loadings, to ensure that the fiber structure from one of the fiber-composite layers does not affect the surface. The surface of the structural component with the plastics foil applied can moreover be adapted individually to be appropriate for the surface properties required for the planned use, for example in respect of coloring and structuring, etc. The additional plastics foil can also prepare the structural component for an additional coating, for example a coating layer that is to be applied. The plastics foil can moreover also be designed as scratch-resistant outer layer, and thus replace conventional coating, in particular if it has been provided with a UV-hardenable lacquer system.

The plastics foil is preferably a foil made of polycarbonate or of a polycarbonate mixture. Use of a foil of this type produces good adhesion to the corresponding fiber-composite layer, in particular when this likewise comprises a polycarbonate matrix. This method moreover achieves a structural component with high resistance to temperature change, in particular for subsequent forming processes.

The thickness of the foil is preferably in the range from 25 to 1000 μm, more preferably in the range from 50 to 500 μm, and in particular in the range from 75 to 250 μm.

In one embodiment of the process, during the thermoforming of the first or of the second fiber-composite sheet, a foil made of a thermoplastic is arranged in such a way in a forming mold used during the thermoforming process that, after the thermoforming process, it has bonded coherently to the corresponding semifinished fiber-composite product.

It has been found that a foil of this type can be bonded to the fiber-composite sheet directly during the thermoforming of the latter. This firstly can give a uniform and stable, full-surface bond between the foil and the fiber-composite sheet or the semifinished fiber-composite product produced. Secondly, this avoids use of an additional application step for the application of the foil to the semifinished fiber-composite product.

In another embodiment of the process, the foil is subjected to thermal preforming before arrangement in the forming mold. It has been found that preforming of the foil permits uniform application of the foil to the semifinished fiber-composite product, in particular with avoidance of creasing.

In another embodiment of the structural component, there is a coating layer applied on that side of the first and/or of the second fiber-composite layer that faces away from the foam layer, or on a plastics foil applied thereon. It has been found that, in particular with a plastics foil applied on a fiber-composite layer, the structural component has good coating properties which in particular avoid any effect on the coating caused by the fiber structure. The coating layer can have a plurality of sublayers, for example with a first layer made of a primer system to prepare the substrate for further layers, a second layer made of a basecoat, and a third layer made of a clearcoat. In particular, the coating layer can comprise a colored basecoat and, applied thereon, a transparent clearcoat which can by way of example achieve a deep-gloss effect. The coating layer can by way of example comprise the following layers: a first layer made of a primer system, a layer made of red-metallic basecoat, and a third layer made of a high-gloss clearcoat.

The thickness of the coating layer is preferably from 15 to 300 μm, more preferably from 15 to 100 μm, in particular from 20 to 50 μm.

In another embodiment of the structural component, the first and the second fiber-composite layer are in direct contact with one another in at least one peripheral region of the structural component. The expression “direct contact with one another” here means that in the peripheral region the two fiber-composite layers are in contact with one another without any foam-layer part arranged therebetween. However, there can be by way of example a thin adhesive layer arranged between the first and second fiber-composite layer, but in this case the first and second fiber-composite layer here are still considered to be in essence in direct contact with one another. This embodiment provides a structural component where, at least in the peripheral region, the fiber-composite layers include the foam layer in such a way that firstly the foam layer is protected, for example from mechanical effects or from moisture penetration, and secondly an improved surface character of the structural component is achieved in the peripheral region. It is preferable that the first and the second fiber-composite layer are in direct contact with one another in essence in the entire peripheral region of the structural component in such a way that the two fiber-composite layers in essence completely enclose the foam layer.

In another embodiment of the structural component, the first and/or the second fiber-composite layer are crimped in at least one peripheral region of the structural component. By way of example one of the two fiber-composite layers can be crimped around the respective other fiber-composite layer, or both fiber-composite layers can be crimped together with one another. The fiber-composite layers are thus sealed at the periphery, and by way of example penetration of moisture between the fiber-composite layers can thus be prevented.

When components are used as load-bearing and/or cladding structures, by way of example, of motor vehicle bodywork, it is often necessary to provide force-introducing elements to the components, for example hinges, locks, etc. In the case of the steel sheet components used in the prior art, force-introducing elements can by way of example be welded or riveted to the substructure, or bonded thereto via a supportive bottom-plate structure.

However, the intention of lightweight construction is to use lighter components to replace steel sheet components. An example of an advantageous component that can replace a steel sheet component is the structural component described above. In the case of these components the force-introducing element is advantageously not solely bonded to one of the fiber-composite layers. Welding of a force-introducing element to a fiber-composite layer is often found to be difficult, and often leads to impairment of surface characteristics, or can, during the welding procedure or when force is subsequently introduced, lead to distortion or damage to the structural component, or even to breakaway of the fiber-composite layer. Direct linkage of the force-introducing element to the foam layer is likewise found to be problematic, since the foam layer is relatively soft and therefore makes it difficult to introduce force directly from the force-introducing element. Comparable problems also arise with other structural components having a foam layer.

The structural component described above with anchoring structure provides a structure permitting good force introduction from a force-introducing element into a soft foam, for example into the foam layer of the structural component described above. To this end, the branching structure of the anchoring structure is integrated into the foam layer of the structural component. By virtue of the at least three branches extending from the base in various directions, the branching structure has a higher surface-to-volume ratio than unbranched structures, and a larger interface is therefore available between the branching structure and the foam of the foam layer for force introduction. The three branches moreover permit force introduction in various directions into the foam. It is preferable that the directions of the branches are selected in such a way that they proceed to some extent in the direction of tension and to some extent in the direction of thrust of the force to be introduced. The directions of the branches can in particular be adapted to be appropriate to the force directions usually arising during the planned use. The directions of the branches can in particular be selected in such a way that the forces usually arising during the planned use are deflected to become tensile forces, i.e. that the forces in essence act in the longitudinal direction of the branches.

In one example of the anchoring structure, the at least three branches extending from the base in various directions are in essence in one plane. Insofar as the branching structure comprises more than three branches, it is preferable that all of these branches are in essence in one plane. It is thus possible even to introduce the branching structure into a foam layer of thickness much smaller than its length and width, as by way of example can be the case with the foam layer of the structural component described above.

That end of a branch that is further distant from the base is hereinafter termed distal end of said branch. The other end of the respective branch is correspondingly termed proximal end.

The directions of the three branches are preferably selected in such a way that they in essence have uniform distribution around the base. It is thus possible to introduce force in various directions. It is particularly preferable that the directions of the three branches are selected in such a way that the base is within an imaginary triangle drawn between the distal ends of the three branches. It is preferable to maximize the area of the imaginary triangle.

In another embodiment of the anchoring structure, the base has a connection region in essence extending perpendicularly to the plane of the branches, for linkage to a force-introducing element. The connection region can by way of example take the form of a connector. When the branching structure is embedded in a foam layer it is thus possible to provide a connection region which preferably protrudes from the foam layer and to which a force-introducing element can be attached.

If this type of anchoring structure with its branching structure is integrated into the foam layer in a structural component described above, the connection region extends in the direction of the first or second fiber-composite layer. The connection region can preferably protrude to some extent into the first or second fiber-composite layer or penetrate the latter completely, in such a way that a force-introducing element can be attached on the connection region of the anchoring structure and thus on the structural component.

In another embodiment, at least from one branch of the branching structure of the anchoring structure, at least one further branch extends. The branching structure thus provided has a branching level greater than one and firstly has a more advantageous surface-to-volume ratio, and secondly also improves the interlock bonding of the branching structure within a foam. The branching level of the branching structure is preferably at least 2, more preferably at least 3, in particular at least 4. The expression “branching level of the branching structure” means the maximal number of branches from the base to a distal end of a branch of the branching structure. If, by way of example, the branching structure exclusively has branches without further branching, the level of branching is equal to 1. If there is a further branch branching from at least one of said branches, the branching level is equal to 2. If there is at least one further branch branching from said second-level branch, the level of branching is equal to 3, etc. A greater level of branching of the branching structure achieves a more advantageous surface-to-volume ratio and better interlock bonding of the branching structure in a foam.

In another embodiment, the stiffness, in particular the tensile and/or flexural stiffness, of at least one, preferably in essence all, branches of the branching structure of the anchoring structure decreases in the distal direction. The expression “distal direction” means the direction toward the distal end of the respective branch. By virtue of decreasing stiffness in the distal direction, the branches allow greater deformation in the distal direction during force introduction. This achieves force introduction not solely in the region of the base or in the region near to the base of the anchoring structure but also in essence over the entire length of the branches.

If a branch has constant stiffness over its length, the result of a force exerted from a force-introducing element onto the anchoring structure, for example a tensile force, is that the branch is forced against the surrounding foam only in the region close to the base, and force introduction is therefore also achieved only in said region. In contrast, the effect of decreasing stiffness in the distal direction is that the corresponding branch is forced against the surrounding foam in essence over the entire length of said branch, and force introduction is therefore also in essence achieved over the entire length of the branch. If the level of branching of the branching structure is greater than 1, it is preferable that stiffness, in particular tensile and/or flexural stiffness, decreases from each branching level to the next.

It is preferable that the design of at least one branch of the branching structure is such that when a force is introduced into the anchoring structure, force introduction from the branch into the foam of a foam layer surrounding the branch takes place over at least 25%, preferably at least 50%, in particular at least 75%, of the length of the relevant branch. This can by way of example be achieved in that the stiffness of the branch decreases in the distal direction. It is preferable that in essence all branches of the branching structure are designed accordingly.

In another embodiment, the cross section of at least one branch of the branching structure of the anchoring structure decreases in the distal direction. It is thus easily possible to achieve a decrease of stiffness, in particular tensile and/or flexural stiffness, in the distal direction. This approach can moreover save material.

In another embodiment, at least one branch of the branching structure of the anchoring structure, preferably in essence all branches of the branching structure, has/have a plurality of apertures extending through the branch. It is thus possible to improve integration of the branching structure into a foam layer, thus in particular producing a better interlock bond between the foam and the branching structure. The expression “aperture extending through the branch” means a tunnel-like aperture extending from one side of the branch to another side of the branch. This aperture can by way of example have an angular cross section, as in the case of a grid, or else a rounded or round cross section.

In another embodiment, at least one branch of the branching structure of the anchoring structure is of ribbed design. It is preferable that in essence all branches of the anchoring structure are of ribbed design. It is thus possible to provide a plurality of apertures extending through the branch, thus permitting improvement of the interlock bond between a foam and the branching structure. The expression “ribbed design” means that the relevant branch comprises a plurality of longitudinal struts and a plurality of transverse struts, thus giving a grid-like overall structure of the branch.

In another embodiment, the anchoring structure consists essentially of a plastic. It is thus possible to provide a lightweight anchoring structure for lightweight construction. Examples of suitable and preferred plastics are polycarbonates, polypropylenes, polyalkylene terephthalates, polyamides, and mixtures thereof. The anchoring structure can also alternatively be composed of metals or metal alloys, preferably of aluminum or an aluminum alloy. Again, this approach can provide a lightweight anchoring structure.

In another embodiment, the anchoring structure is produced by injection molding. This approach also permits cost-effective production of a complex branching structure of the anchoring structure.

In another embodiment, there is a force-introducing element attached to the base of the anchoring structure. The force-introducing element can by way of example be a hinge or a part of a lock. The force-introducing element can moreover be a separate component, or can be of one-piece design with the anchoring structure.

It has been discovered that with the anchoring structure, the branching structure of which has been embedded into the foam layer, it is possible to achieve direct force introduction from a force-introducing element, for example a hinge, into the lightweight component. By virtue of the branching structure it is possible to introduce a force into the foam layer over a large area and over a large region, thus also permitting introduction of a considerable force into the relatively soft foam layer.

Direct force introduction into one of the fiber-composite layers would, in contrast, not be possible, because welding of a force-introducing element to one of the fiber-composite layers would lead to visible defects on the surface of the fiber-composite layer and/or to disadvantageous alterations or stresses in the fiber-composite layer, caused by heat. Adhesive bonding of a force-introducing element to one of the fiber-composite layers would, when a force is introduced, lead to local deformation of the fiber-composite layer and sometimes also to disadvantageous alterations or stresses in the fiber-composite layer, caused by heat.

With the anchoring structure described above it is possible to avoid this type of disadvantageous direct force introduction into the fiber-composite layers. Because in essence all of the force is introduced into the foam layer, it is moreover also possible to omit additional reinforcing structures at the point of force-introduction, i.e. in the region of the accommodating space.

The material of the anchoring structure, in particular of the branching structure of the anchoring structure, and the material of the foam layer have preferably been adjusted to be appropriate to one another in such a way that the materials adhere to one another. This approach produces not only an interlock bond and/or frictional bond between the foam of the foam layer and the branching structure but also a coherent bond, because the foam adheres to the anchoring structure at the surface. This can be achieved by way of example with a foam layer made of PU foam through the use of a polycarbonate mixture for the anchoring structure. Alternatively it is also possible to use, for the foam layer and the branching structure, materials which do not adhere to one another, or adhere only slightly to one another, for example polypropylene for the branching structure in a PU foam. In this case, force introduction from the branching structure into the foam of the foam layer is still possible by way of the interlock bond and/or frictional bond between the foam of the foam layer and the branching structure.

It is preferable that the first or the second fiber-composite layer has an accommodating space and that the anchoring structure extends into said accommodating space. In this approach the anchoring structure extends into the region of the fiber-composite layer in such a way that at this point it is possible to connect a force-introducing element to the structural component. This approach also simplifies the production of the structural component, because during the production process the anchoring structure can be fixed in the accommodating space before the foam layer is introduced. The accommodating space can by way of example take the form of an aperture in the first or second fiber-composite layer through which a part of the anchoring structure extends.

It is preferable to select, for the branching structure of the anchoring structure, a material having a coefficient of thermal expansion similar to that of the foam layer, in particular with a coefficient of thermal expansion differing from that of the foam layer by less than 10%, in particular less than 5%. When temperature change occurs, this approach can reduce, or indeed prevent, deformation of the structural component and/or exposure of the anchoring structure to load.

In one embodiment of the process, a functional element or an anchoring structure is arranged in such a way in an accommodation space introduced into the first or the second semifinished fiber-composite product that a part of the functional element protrudes into, or the branching structure of the anchoring structure protrudes into, the cavity and, when foam is introduced into the cavity, is embedded there by the foamed plastic. This approach allows the functional element and/or the branching structure to be integrated in a simple manner into the structural component directly during the production of the latter, so that it is possible to provide a structural component which already comprises the functional element and/or the anchoring structure, and into which it is no longer necessary to install said element and/or structure subsequently, to the extent that such installation would actually be possible.

In connection the object described above is achieved at least to some extent via the use of a structural component described above for the production of a component group, in particular for vehicle bodywork, comprising the structural component and a force-introducing element secured at the anchoring structure of the structural component, said element being in particular a hinge. The component group can by way of example be a tailgate with a hinge as force-introducing element.

The object is moreover at least to some extent achieved via a component group of this type, in particular for vehicle bodywork, comprising the structural component and a force-introducing element secured at the anchoring structure of the structural component, in particular a hinge. The component group can by way of example be a tailgate with a hinge as force-introducing element.

It has been found that with the anchoring structure described it is possible to attach force-introducing elements directly, examples being hinges, made of various materials such as metal or plastic, in particular a plastics mixture, in particular a polycarbonate-containing plastics mixture, in particular a polycarbonate-polyester mixture. It is thus possible to connect the structural components directly and in a simple manner to a force-introducing element, such as a hinge, in such a way that the structural components are in particular advantageous for use as part of a tailgate or engine hood.

In another embodiment, the structural component comprises a functional element embedded at least to some extent into the foam layer, in particular an optical, electrical, and/or electronic element. It has been found that functional elements can be integrated successfully into the structural component, in particular into the foam layer, and therefore that this approach can provide structural components with appropriately integrated functional elements. The expression “functional elements” means elements which have particular functional properties, for example optical elements in the form of optical conductors or lenses, or electrical or electronic elements in the form of light sources, light sensors, transmitters, or receivers, including in particular optical, electrical, or electronic receivers.

In particular, one of the two fiber-composite layers can have an appropriate accommodating space or cutout for the functional element, the intention here being by way of example that an optical conductor embedded in the foam layer can be brought to the surface of, or to a point just below the surface of, the structural component, and can emit light at that location.

It is preferably possible to apply a semipermeable optical layer onto one of the two fiber-composite layers in the region of the accommodating space or cutout. This approach can provide, on the structural component, a surface region which firstly at least to some extent permits transmission of light from an optical element arranged thereunder, in such a way that the light is visible from the outside (for example in the form of illuminated pictogram), and which secondly covers the optical element when the latter emits no light, in such a way that said surface region appears to merge into the base color of the layer. Another term used for a layer of this type is a day-night-design layer.

Other features and advantages of the present invention are described below by taking embodiments with reference to the attached drawing.

The drawings show the following:

in FIG. 1 a fiber-composite sheet as starting workpiece for the production of a multilayer structural component as in one embodiment of the invention,

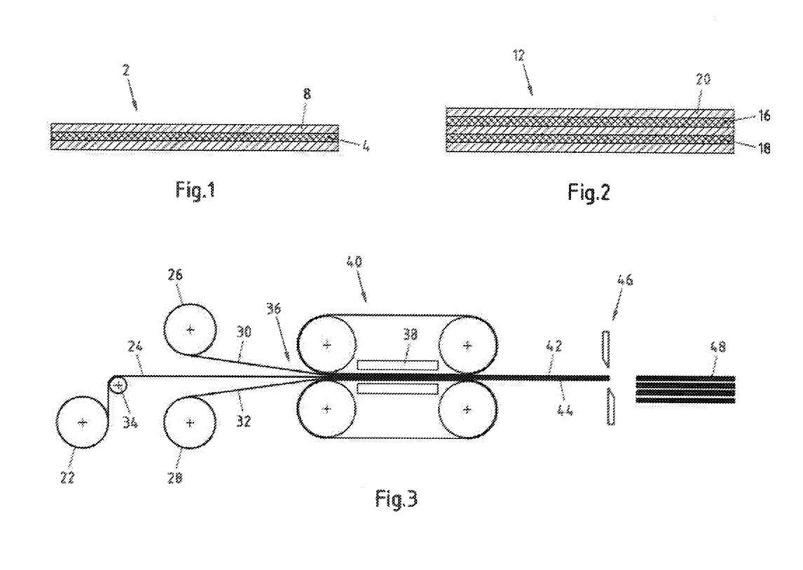

in FIG. 2 another fiber-composite sheet for the production of a multilayer structural component as in another embodiment of the invention,

in FIG. 3 a diagram of examples of steps for the production of fiber-composite sheets,

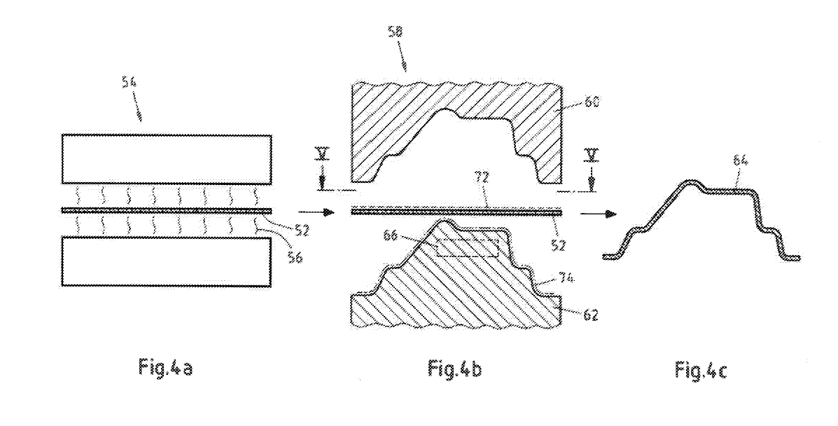

in FIG. 4 a diagram of the steps for the production of a semifinished fiber-composite product made of a first fiber-composite sheet as in one embodiment of the invention,

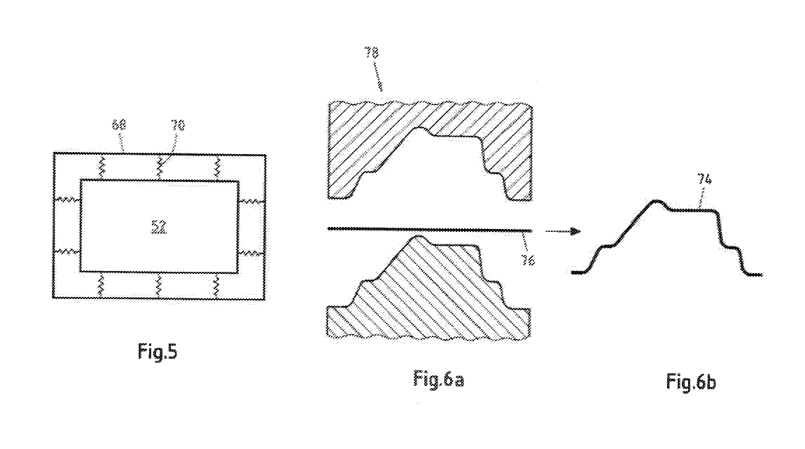

in FIG. 5 a sectional view corresponding to the sectional plane indicated by “V” in FIG. 4,

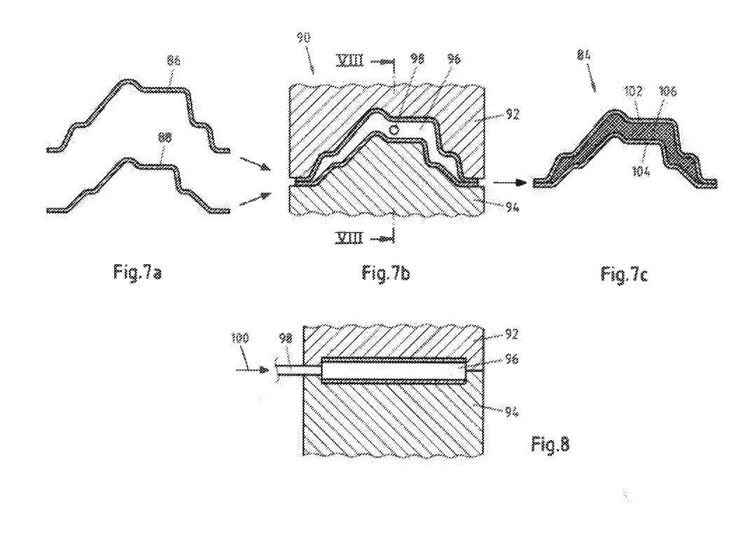

in FIG. 6 a diagram of the steps for the production of a preformed plastics foil for another embodiment of the process of the invention,

in FIG. 7 a diagram of the steps for the production of a multilayer structural component made of two semifinished fiber-composite products as in one embodiment of the invention,

in FIG. 8 a sectional view corresponding to the sectional plane indicated by “VIII” in FIG. 7,

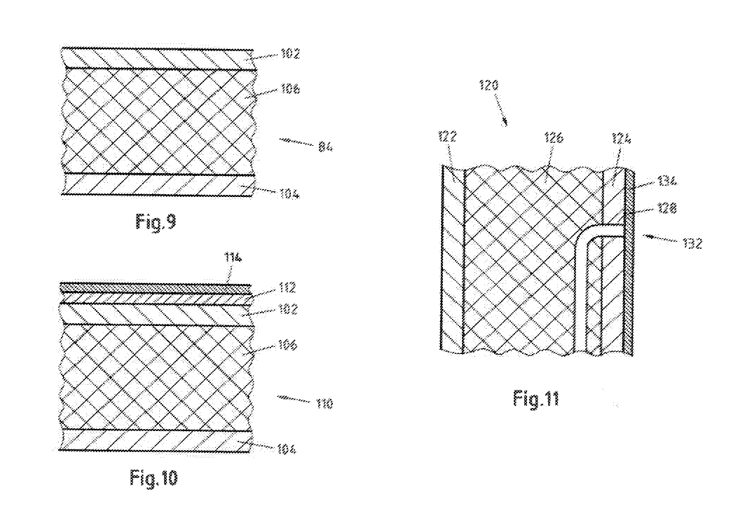

in FIG. 9 a cross-sectional diagram of a multilayer structural component as in one embodiment of the invention,

in FIG. 10 a cross-sectional diagram of a multilayer structural component as in another embodiment of the invention,

in FIG. 11 a cross-sectional diagram of a multilayer structural component as in another embodiment of the invention with an embedded functional element,

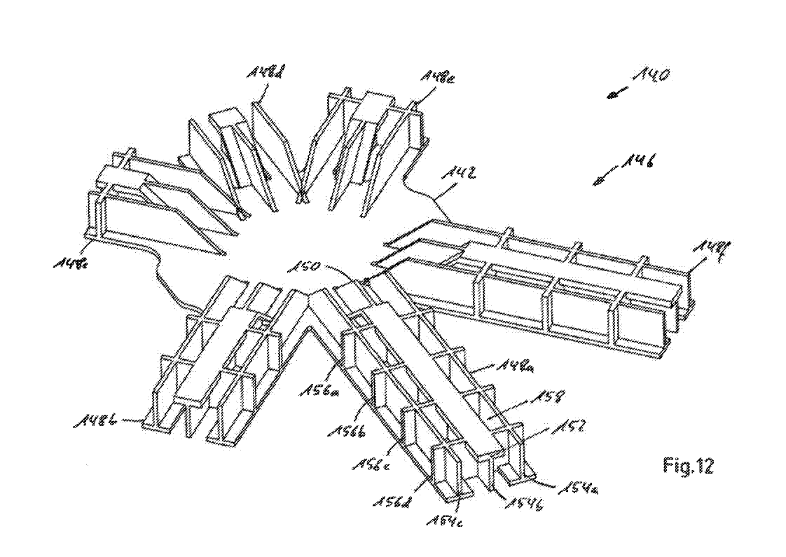

in FIG. 12 a perspective view of an anchoring structure for a multila ctural component as in one embodiment of the invention,

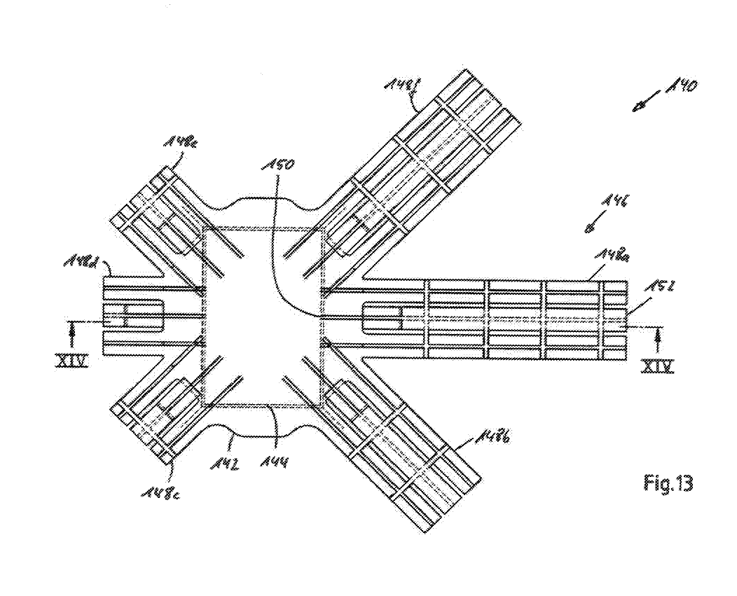

in FIG. 13, a plan view of the anchoring structure from FIG. 12,

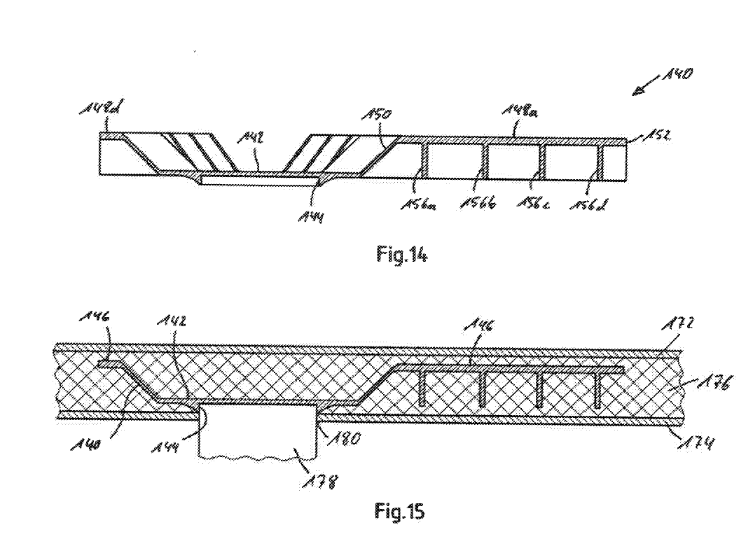

in FIG. 14 the anchoring structure from FIG. 12 in cross section along the sectional line XIV indicated in FIG. 13, and

in FIG. 15 a multilayer structural component as in another embodiment of the invention, with the anchoring structure from FIG. 12 integrated into said component.

Embodiments of the process of the invention for the production of a multilayer structural component are illustrated below with reference to FIGS. 1 to 8.

Conduct of the process firstly requires provision of a first and a second fiber-composite sheet. FIG. 1 shows a sectional side view of an example of a fiber-composite sheet 2 of this type suitable for the process, with a fiber ply 4 made of a woven glassfiber fabric embedded into a matrix 8 made of thermoplastic. FIG. 2 shows a sectional side view of a fiber-composite sheet 12 likewise suitable for the process, comprising a first fiber ply 16 and a second fiber ply 18 made of a woven carbon-fiber fabric. The fiber plies 16, 18 have been embedded into a matrix 20 made of thermoplastic. It is also alternatively possible that the fiber-composite sheet used for the process has a larger number of fiber plies, in particular also made of other woven fiber fabrics.

FIG. 3 depicts an example of a production process for a fiber-composite sheet with a fiber ply. In the process a fiber ply 24 in the form of strip is unwound from a first reel 22, and a plastics foil 30, 32 in the form of strip is unwound respectively from a second and third reel 26, 28. By means of guide rolls 34, the fiber ply 24 and the plastics foil 30, 32 are mutually superposed to give a layer structure 36, and introduced into a twin-belt press 40 heated by means of heating elements 38. In the twin-belt press 40 the layer structure 36 is pressed to give a fiber-composite material 42 through the action of pressure and heat. The temperatures of the twin-belt press here are high enough to cause at least partial melting of the plastics foils 30, 32 of the layer structure 36, and to cause the plastics foils 30, 32 of the layer structure 36 to form a matrix embedding the fiber ply 24. The fiber-composite material 42 emerging as continuous strip 44 from the twin-belt press 40 can then be introduced into a finishing device 46 in which the strip 44 by way of example is cut to give fiber-composite sheets 48.

A production process is described by way of example. By increasing the number of the reels it is also possible in comparable fashion to produce fiber-composite sheets with a plurality of fiber plies. In particular it is possible to use five reels for the fiber-composite sheet 12 shown in FIG. 2, two of which carry a fiber ply and three of which carry a plastics foil.

The first and second fiber-composite sheet provided are then thermoformed to give a first and second semifinished fiber-composite product.

The steps for the production of a semifinished fiber-composite product made of a fiber-composite sheet via thermoforming as in one embodiment of the invention are now illustrated with reference to FIGS. 4a-c.

As depicted in FIG. 4a, this is achieved by firstly heating a fiber-composite sheet 52 in an oven 54, for example in an infrared oven emitting infrared radiation 56, to a temperature above the softening points of the plastic of the matrix of the fiber-composite sheet 52, in such a way that the fiber-composite sheet becomes deformable.

The fiber-composite sheet is then, as depicted in FIG. 4b, arranged in a forming mold 58. The forming mold has an upper mold half 60 and a lower mold half 62, the shapes of which have been adapted to be appropriate to the shape of the semifinished fiber-composite product 64 to be produced. When the two mold halves 60, 62 are brought together the fiber-composite sheet 52 is subjected to forming to give a semifinished fiber-composite product 64.

In order to avoid premature resolidification of the semifinished fiber-composite product 64, the temperature of the upper and/or the lower mold half 60, 62 can be controlled by heating elements 66 intended for that purpose, for example to a temperature just below the softening point.

During the forming process, various regions of the fiber-composite sheet 52 are stretched or compressed to various extents depending on the shape of the semifinished fiber-composite product 64 to be produced. In order to prevent distortion or fracture of the fiber-composite sheet here, and creasing, the semifinished fiber-composite product can be clamped into a frame before the forming process. The sectional view in FIG. 5 along the sectional line indicated by “V” in FIG. 4b depicts a frame 68 of this type. The fiber-composite sheet is clamped in the frame 68 peripherally by use of springs 70, for example helical springs, where the tensions of the individual springs 70 have been adapted to be appropriate for the degree of deformation of the corresponding region of the fiber-composite sheet during the forming process. The springs 70 thus assist the location-dependent stretching and, where appropriate, compression of the fiber-composite sheet 52 during the forming process, and prevent creasing, i.e. mutual superposition of parts of the fiber-composite sheet.

During the forming process to give the semifinished fiber-composite product 64 it is also possible that the fiber-composite sheet 52 is simultaneously coated with a plastics foil. For this purpose it is possible to arrange a plastics foil 72 (depicted by broken line in FIG. 4b) on the fiber-composite sheet 52 before the follning process. When the two mold halves 60, 62 are brought together, the plastics foil is then subjected to forming together with the fiber-composite sheet 52 and thus bonded coherently thereto.

It is also alternatively possible to insert a preformed plastics foil 74 (depicted by a dash-dot line in FIG. 4h) into the mold 58. The advantage with the use of a preformed plastics foil is that this has already been prestretched in accordance with the final shape of the semifinished fiber-composite product 64, and thus firstly gives better bonding between the preformed plastics foil 74 and the semifinished fiber-composite product 64, and secondly prevents fracture or mutual superposition of the plastics foil in the forming process.

A preformed foil such as the plastics foil 70 can by way of example be produced as depicted in FIGS. 6a-h by subjecting a plastics foil 76 to a forming process in a forming mold 78.

FIGS. 7a-c then illustrate the steps for the production of a multilayer structural component 84 made of two semifinished fiber-composite products 86, 88 as in one embodiment of the invention. The semifinished fiber-composite products 86, 88 can have been in particular produced in the same way as the semifinished fiber-composite product 64 by using the steps illustrated in FIGS. 4a-c. The semifinished fiber-composite products 86, 88 can have the same shape or (as is the case in FIG. 7a) different shapes. In particular for this purpose they can also have been produced by using different forming molds.

The first and the second semifinished fiber-composite product 86, 88 are, as depicted in FIG. 7b, arranged in a foaming mold 90. The foaming mold 90 has an upper mold half 92 and a lower mold half 94, where the shape of the upper mold half 92 has been adapted to be appropriate to the shape of the first semifinished fiber-composite product 86 and the shape of the lower mold half 94 has been adapted to be appropriate to the shape of the second semifinished fiber-composite product 88. The first semifinished fiber-composite product 86 is inserted into the upper mold half 92, and held there by way of example by subatmospheric pressure. The second semifinished fiber-composite product 88 is inserted into the lower mold half 94. When the mold halves 92, 94 are brought together a cavity 96 is formed between the first and the second semifinished fiber-composite product 86, 88.

In the plane of the drawing of FIG. 7b the cavity 96 is delimited by the semifinished fiber-composite products 86, 88, the edges of which are respectively in direct contact with one another. In the direction perpendicular to the plane of the drawing, the cavity 96 is delimited (as depicted in the sectional view in FIG. 8 along the sectional plane indicated by VIII in FIG. 7b) by appropriately designed lateral areas of the mold halves 92, 94.

The mold 90 has an inlet 98 extending into the cavity 96 for the injection of a foaming plastic. Once the first and second mold half 92, 94 have been brought together, a foaming plastic, for example polyurethane, is injected through said inlet 98 into the cavity 96 (cf. arrow 100), in such a way as to fill said cavity with the foaming plastic.

Once the plastic has hardened, the two semifinished fiber-composite products 86, 88 have been bonded securely to one another by the foam layer situated therebetween, formed by the plastic, and the finished structural component 84 can be removed from the foaming mold 90.

FIG. 9 depicts a cross section of the multilayer structural component 84. Accordingly, the structural component has a first and a second fiber-composite layer 102, 104 and, arranged therebetween, a foam layer 106 made of foamed plastic. The fiber-composite layers 102, 104 produced from the semifinished fiber-composite products comprise respectively at least one fiber ply which is made of a fiber material which has been embedded into a matrix based on a thermoplastic.

FIG. 10 shows another embodiment of a multilayer structural component 110, which differs from the multilayer structural component 84 from FIG. 9 by virtue of a plastics foil 112 which has additionally been applied to the fiber-composite layer 102 and which forms an additional plastics layer on the fiber-composite layer 102, and also by virtue of a layer 114 of coating material applied thereto. The structural component 110 can by way of example be produced by bonding, for example as described above with reference to FIG. 4h, a plastics foil to the semifinished fiber-composite product for the first fiber-composite layer 102 during the production of said semifinished product.

FIG. 11 shows an alternative embodiment of a structural component 120 with a first and a second fiber-composite layer 122, 124 and, arranged therebetween, a foam layer made of foamed plastic 126. The fiber-composite layer 124 has an accommodation space 128 into which a functional element 130 has been placed; said element protrudes into the region of the foam layer 126, which has been injected around same. The functional element 130 can by way of example be an optical conductor which has applied connection to a light source and which can provide a region 132 of illumination on the side of the fiber-composite layer 124. For this purpose there can be, on the fiber-composite layer 124, a semipermeable optical layer 134 applied which, when the light source is switched on, allows the light conducted through the optical conductor to pass and thus to become visible from the outside, and when the light source has been switched off renders the optical conductor invisible from the outside. In particular, when the light source has been switched off the layer 134 can appear black from the outside.

The structural component 120 depicted in FIG. 11 can be produced in a simple manner, for example in that before the foaming mold halves 92, 94 are brought together in the step depicted in FIG. 7c the functional element 130 is inserted into an appropriately provided accommodation space in one of the two semifinished fiber-composite products in such a way that when the foaming plastic is injected it is injected around that part of the functional element 130 that protrudes into the cavity 96.

The present invention further provides a process for the production of a structural component (84, 110, 120, 170),
where a first and a second fiber-composite sheet (2, 12, 48, 52) are provided, where the first and the second fiber-composite sheet (2, 12, 48, 52) respectively have at least one fiber ply (4, 16, 18, 24) which is made of a fiber material and which has been embedded into a matrix (8, 20) based on a thermoplastic,
where the first fiber-composite sheet (2, 12, 48, 52) is thermoformed to give a first semifinished fiber-composite product (64, 86, 88), and the second fiber-composite sheet (2, 12, 48, 52) is thermoformed to give a second semifinished fiber-composite product (64, 86, 88)
where the first and the second semifinished fiber-composite product (64, 86, 88) are arranged in a foaming mold (90) in such a way that, between the first and the second semifinished fiber-composite product (64, 86, 88), a cavity (96) is formed, and is filled by a polymeric, preferably thermoset, foam, preferably by foaming in situ.

In this way it is also possible to integrate other functional elements into the multilayer structural component described above.

An anchoring structure for a multilayer structural component as in one embodiment of the invention is described below with reference to FIGS. 12 to 14. The anchoring structure 140 is depicted in FIG. 12 in perspective view, in FIG. 13 in plan view and in FIG. 14 in cross section along the sectional line XIV indicated in FIG. 13.

The anchoring structure 140 has a flat base 142 for linkage to a force-introducing element. The base 142 has an accommodation space 144 for a force-introducing element or for a linkage element by way of which it is possible to bond the base 142 to a force-introducing element. The anchoring structure 140 moreover has a branching structure 146 which, in the case of the example depicted in FIG. 12, comprises six branches 148a-f extending from the base in various directions. The structure of the branches 148a-f is explained below with reference to the branch 148a:

The branch 148a extends from its proximal end 150 at the base 142 to the distal end 152. The branch 148a has three longitudinal ribs 154a-c and four transverse ribs 156a-d, and thus is of ribbed design. The longitudinal ribs 154a-c have respectively a T-shaped profile. By virtue of the ribbed design of the branch 148a this has a plurality of apertures 158 extending through the branch 148a. When a foam is injected around the branching structure 146, the foam therefore penetrates into the apertures 158 of the branch 148a and thus brings about a better interlocking bond between the foam and the branch 148a. The surface area of the branch 148a is moreover thus enlarged, and introduction of a force into the foam can therefore take place over a larger surface area.

The branches 148a-d can, as depicted in FIG. 12, have different length and thus optionally a different number of transverse ribs. It is preferable that the direction of the branches 148a-d and the length thereof has been adapted to be appropriate for the available installation space within the structural component into which the anchoring structure 140 is to be integrated.

The anchoring structure 140 depicted in FIGS. 12 to 14 can by way of example have been produced from a plastic, preferably by injection molding. The anchoring structure 140 can also alternatively be composed of an aluminum alloy.

The anchoring structure 140 can be still further improved in that the branches 148a-d have decreasing stiffness in distal direction, i.e. in the direction of their respective distal end. For this purpose by way of example the cross section of the branches 148a-d can decrease in the distal direction. This can by way of example be achieved in that the wall thickness and/or the number of the longitudinal ribs of the branches 148a-d decrease toward the distal end. It is moreover possible to design the branching structure 140 with a higher level of branching. Whereas the level of branching in the case of the branching structure depicted in FIG. 12 is 1, other embodiments can have subbranches starting from the branches 148a-d. These additional branches of the second level of branching can by way of example be subbranches from the exterior longitudinal ribs 154a and 154c. It is also alternatively possible that the two exterior longitudinal ribs 154a and 154e themselves proceed at an angle from the branch 148a in respectively a different direction and thus form branches of the second level of branching.

FIG. 15 shows a sectional view of a multilayer structural component as in another embodiment of the invention into which the anchoring structure 140 depicted in FIG. 12 has been integrated. The multilayer structural component 170 has a structure like that of the structural component 84 depicted in FIG. 9 with a first fiber-composite layer 172, a second fiber-composite layer 174 and, arranged therebetween, a foam layer 176 into which the branching region 146 of the anchoring element 140 has been embedded. A tenon-shaped linking element 178 has been inserted into the accommodation space 144 of the base 142 of the anchoring structure 140 and extends transversely to the plane of the branches 148a-f through an aperture 180 in the second fiber-composite layer 174, and thus provides an opportunity for connection of a force-introducing element. It is also alternatively possible to insert a force-introducing element directly into the accommodation space 144. The linkage element 178 or the force-introducing element can by way of example be bonded coherently to the base 142 at the accommodation space 144. It is also possible to use a one-piece (integral) design for the anchoring element 140, the linkage element 178, and/or the force-introducing element.

If a force is exerted onto the linkage element 178 or onto the force-introducing element this is transmitted to the base 142 and then to the branching structure 146 of the anchoring structure 140. By virtue of the large surface area of the branches 148a-f it is thus possible to achieve effective force introduction into the relatively soft foam of the foam layer 176. This is in particular assisted if the stiffness of the branches 148a-d decreases in distal direction.

The structural component 170 can be produced by way of example in that an aperture corresponding to the aperture 180 is provided to the fiber-composite sheet used to fortn the second fiber-composite layer 174, and then the anchoring structure 140 with the linkage element 178 or the force-introduction element is inserted into said aperture in such a way that the branching structure 146 is arranged in the cavity depicted in FIG. 7b. When the foaming plastic is injected into the cavity for the production of the foam layer 176, the plastics foam is then injected around the branching structure 146, whereupon the plastics foam in particular also penetrates through the apertures 158 provided in the branches 148a-d, and a large interface is thus produced between the branching structure 146 and the foam of the foam layer 176.

With an anchoring structure of this type, for example the anchoring structure 140, it is in particular possible to achieve transmission of a point force or of a force acting on an area that is small relative to the structural component, into a material with relatively low density, in particular into a foam layer. The structural component in which the anchoring structure has been integrated can by way of example be a tailgate of a motor vehicle, and there can be a hinge as force-introducing element bonded to said tailgate by way of the anchoring structure. The force exerted by the hinge is a point force in relation to the size of the tailgate, and is transmitted by way of the base into the branching structure of the anchoring structure and thus introduced into the foam, e.g. polyurethane foam, the foam layer of the component.

This spreading of the force flow over a plurality of branches of the branching structure permits uniform introduction of the force into the foam layer. Use of the branching structure or of a structural component with integrated branching structure thus in particular achieves the object of introducing, into a soft material, a greater stress (=force per unit layer) than would be permitted by the strength values of the relatively soft material with point-fastening.

It is preferable that the cross section of the branches decreases from the force-introduction point, i.e. from the base, to the distal end of a branch. It is preferable that the decrease of the cross section of the branches has been adapted in such a way that the local cross section, and thus the strength or stiffness of the branches has been adapted to be appropriate to the respective residual force to be transmitted by the corresponding distal branch section.

In the case of the tailgate example described above, with a hinge secured by way of the anchoring structure, the cross section of the branches can by way of example be from 2 to 3 mm in the region of the base and decrease to from 0.5 to 1 mm when the distal end of the branches is reached.

It is preferable that the length and number of the branches has been adapted to be appropriate to the adhesion, or tendency to adhere, of the foam material to the material of the branches.

The geometric properties of the anchoring structure, in particular the number, lengths, directions, and/or cross sections of the branches, have preferably been adapted to be appropriate to the maximal forces to be expected for the planned use of the anchoring structure or of the structural component with integrated anchoring structure. It is thus possible to avoid exceeding the maximal shear stress, whereas otherwise the anchoring structure could be torn away from the foam layer.

The branches of the anchoring structure can have various lengths, and/or the branches can have asymmetric distribution around the base. In particular, the lengths and/or the directions of the branches can be adapted to be appropriate for the expected direction of force introduction via the force-introducing element, for example of a hinge, and/or to the installation space available.

It is preferable that the material of the anchoring structure, in particular of the branching region and also the material of the foam layer, have been adapted to be appropriate to one another in such a way that they have high adhesion to one another. A combination of polycarbonate-based materials has proven in particular to be very suitable for the anchoring structure here, with polyurethane foams for the foam layer.

The branches can have ribs or transverse struts, and stiffening elements respectively perpendicularly to the main direction of extension of the branches. It is thus possible to achieve a further increase in the extent of interlocking bonding between the branches and the foam. It is moreover possible per se to provide relatively high intrinsic stiffness to the anchoring structure, thus permitting easier production thereof.

The present disclosure in particular also includes the following embodiments:
1. Multilayer structural component
   comprising a first and a second fiber-composite layer and, arranged therebetween, a foam layer made of foamed plastic,
   where the first and the second fiber-composite layer respectively have at least one fiber ply which is made of a fiber material and which has been embedded into a matrix based on a thermoplastic,
where the structural component comprises an anchoring structure
   with a base for linkage to a force introducing element, and
   with a branching structure, where the branching structure comprises at least three branches extending from the base in various directions,
and where the branching structure of the anchoring structure has been embedded into the foam layer.
2. Structural component as in embodiment 1,
   characterized in that
   the matrix of the first and/or of the second fiber-composite layer is based on a thermoplastic, where the thermoplastic is selected from polycarbonate, polyalkyl acrylates, polyamide, and mixtures of these thermoplastics with, for example, polyalkylene terephthalates, impact modifiers such as arylate rubbers, ABS rubbers and/or additives such as mold-release agents, heat stabilizers, and UV absorbers.
3. Structural component as in embodiment 1 or 2,
   characterized in that
   the fiber ply of the first and/or of the second fiber-composite layer takes the form of unidirectional fiber ply, of woven-fabric ply, of random-fiber ply, or of combinations thereof.
4. Structural component as in any of embodiments 1 to 3,
   characterized in that
   the fiber material of the first and/or of the second fiber-composite layer comprises fibers made of one or more of the following fiber types: glass fibers, carbon fibers, basalt fibers, aramid fibers, and metallic fibers.
5. Structural component as in any of embodiments 1 to 4,
   characterized in that
   the content by volume of the fiber material of the first and/or of the second fiber-composite layer, based on the total volume of the respective fiber-composite layer is in the range from 30 to 60% by volume, preferably in the range from 40 to 55% by volume.
6. Structural component as in any of embodiments 1 to 5,
   characterized in that
   the softening point of the foamed plastic of the foam layer is at least 130° C., preferably at least 150° C., in particular from 150° C. to 200° C.
7. Structural component as in any of embodiments 1 to 6,
   characterized in that
   the plastic of the foam layer is a thermoset, preferably a thermoset based on isocyanates,
8. Structural component as in any of embodiments 1 to 7,
   characterized in that
   the foamed plastic of the foam layer has an apparent core density in accordance with DIN 53420 in the range from 50 to 600 kg/m³, preferably from 100 to 250 kg/m³, and particularly preferably from 140 to 200 kg/m³.
9. Structural component as in any of embodiments
   characterized in that
   the foam layer has at least two subregions with thicknesses differing from one another,
10. Structural component as in any of embodiments 1 to 9,
   characterized in that
   the first and/or the second fiber-composite layer has a thickness in the range from 0.2 to 6.0 mm, preferably from 0.4 to 4.0 mm, in particular from 0.8 to 1.5 mm.
11. Structural component as in any of embodiments 1 to 10,
   characterized in that
   the foam layer has a maximal thickness in the range from 2 to 80 mm, preferably from 8 to 25 mm.
12. Structural component as in any of embodiments 1 to 11,
   characterized in that
   a plastics foil, in particular a polycarbonate foil, has been applied on that side of the first and/or of the second fiber-composite layer that faces away from the foam layer.
13. Structural component as in any of embodiments 1 to 12,
   characterized in that
   a layer of coating material has been applied on that side of the first and/or of the second fiber-composite layer facing away from the foam layer, or on a plastics foil applied thereon.
14. Structural component as in any of embodiments 1 to 13,
   characterized in that
   in at least one peripheral region of the structural component the first and the second fiber-composite layer are in direct contact with one another.
15. Structural component as in any of embodiments 1 to 14,
   characterized in that
   in at least one peripheral region of the structural component the first and/or the second fiber-composite layer have been crimped.
16. Structural component as in any of embodiments 1 to 15,
   characterized in that
   the first or the second fiber-composite layer has an accommodation space, and the anchoring structure extends into the accommodation space.
17. Structural component as in any of embodiments 1 to 16,
   characterized in that
   the structural component comprises a functional element at least to some extent embedded into the foam layer, in particular an optical, electrical, and/or electronic element.
18. Structural component as in any of embodiments 1 to 17,
   characterized in that
   the at least three branches extending from the base in various directions are in essence in one plane.
19. Structural component as in any of embodiments 1 to 18,
   characterized in that
   the base has, for linkage to a force-introducing element, a linkage region extending in essence perpendicularly to the plane of the branches.
20. Structural component as in any of embodiments 1 to 19,
   characterized in that,
   at least from one branch of the branching structure, at least one further branch extends.
21. Structural component as in any of embodiments 1 to 20,
   characterized in that
   the stiffness, in particular the tensile and/or flexural stiffness, of at least one branch of the branching structure decreases in the distal direction.
22. Structural component as in any of embodiments 1 to 21,
   characterized in that
   the cross section of at least one branch of the branching structure decreases in the distal direction.
23. Structural component as in any of embodiments 1 to 22,
   characterized in that
   at least one branch of the branching structure has a plurality of apertures extending through the branch.
24. Structural component as in any of embodiments 1 to 23,
   characterized in that
   at least one branch of the branching structure is of ribbed design.
25. Structural component as in any of embodiments 1 to 24,
   characterized in that
   the anchoring structure consists essentially of a plastic.
26. Structural component as in any of embodiments 1 to 25,
   characterized in that
   at the base a force-introducing element has been attached.
27. Process for the production of a structural component, in particular as in any of embodiments 1 to 26,
   where a first and a second fiber-composite sheet are provided, where the first and the second fiber-composite sheet respectively have at least one fiber ply which is made of a fiber material and which has been embedded into a matrix based on a thermoplastic,
   where the first fiber-composite sheet is thermoformed to give a first semifinished fiber-composite product, and the second fiber-composite sheet is thermoformed to give a second semifinished fiber-composite product,
   where the first and the second semifinished fiber-composite product are arranged in a foaming mold in such a way that, between the first and the second semifinished fiber-composite product, a cavity is formed and
   where a foaming plastic is injected to form a foam in the cavity.
28. Process as in embodiment 27,
   characterized in that
   during the thermoforming of the first or of the second fiber-composite sheet, a foil made of a thermoplastic is arranged in such a way in a forming mold used during the thermoforming process that, after the thermoforming process, it has bonded coherently to the corresponding semifinished fiber-composite product.
29. Process as in embodiment 28,
   characterized in that,
   before arrangement in the forming mold, the foil is subjected to a thermal preforming process.
30. Process as in any of embodiments 27 to 29,
   characterized in that
   a functional element or an anchoring structure, in particular an anchoring structure as in any of embodiments 19 to 28, is arranged in an accommodation space introduced into the first or the second semifinished fiber-composite product in such a way that a part of the functional element or of the anchoring structure protrudes into the cavity and, when foam is introduced into the cavity, is embedded there by the foamed plastic.
31. Use of a structural component as in any of embodiments 1 to 26 for the production of a vehicle bodywork component, in particular of a tailgate, an engine hood, or a roof element.
32. Use of a structural component as in any of embodiments 1 to 26 for the production of a component group, in particular for vehicle bodywork, comprising the structural component and a force-introducing element secured at the anchoring structure of the structural component, said element being in particular a hinge.

1.-18. (canceled)

19. A multilayer structural component
comprising a first and a second fiber-composite layer and, arranged therebetween, a foam layer comprising a foamed plastic,
where the first and the second fiber-composite layer, respectively, have at least one fiber ply which is made of a fiber material and which has been embedded into a matrix based on a thermoplastic,
wherein the structural component comprises an anchoring structure
with a base for linkage to a force-introducing element, and
with a branching structure, where the branching structure comprises at least three branches extending from the base in various directions,
where the branching structure of the anchoring structure has been embedded into the foam layer.

20. The structural component as claimed in claim 19, wherein the matrix of the first and/or of the second fiber-composite layer is based on a thermoplastic.

21. The structural component as claimed in claim 19, wherein the fiber ply of the first and/or of the second fiber-composite layer takes the form of unidirectional fiber ply, of woven-fabric ply, of random-fiber ply, or of combinations thereof.

22. The structural component as claimed in claim 19, wherein the fiber material of the first and/or of the second fiber-composite layer comprises fibers made of one or more of the following fiber types: glass fibers, carbon fibers, basalt fibers, aramid fibers, metallic fibers.

23. The structural component as claimed in claim 19, wherein the content by volume of the fiber material of the first and/or of the second fiber-composite layer, based on the total volume of the respective fiber-composite layer is in the range from 30 to 60% by volume.

24. The structural component as claimed in claim 19, wherein the first or the second fiber-composite layer comprises an accommodation space, and the anchoring structure extends into the accommodation space.

25. The structural component as claimed in claim 19, wherein the structural component comprises a functional element at least to some extent embedded in the foam layer.

26. The structural component as claimed in claim 19, wherein in the branching structure, the at least three branches extending from the base in various directions are in essence in one plane.

27. The structural component as claimed in claim 19, wherein the base comprises a linkage region extending in essence perpendicular to the plane of the branches.

28. The structural component as claimed in claim 19, wherein at least from one branch of the branching structure, at least one further branch extends.

29. The structural component as claimed in claim 19, wherein the stiffness of at least one branch of the branching structure decreases in the distal direction.

30. The structural component as claimed in claim 19, wherein at least one branch of the branching structure comprises a ribbed design.

31. The structural component as claimed in claim 19, wherein a force-introducing element is attached to the base.

32. A process for the production of a structural component as claimed in claim 19, comprising
providing a first and a second fiber-composite sheet, where the first and the second fiber-composite sheet respectively have at least one fiber ply which is made of a fiber material and which has been embedded into a matrix based on a thermoplastic,
thermoforming the first fiber-composite sheet to give a first semifinished fiber-composite product, and thermoforming the second fiber-composite sheet to give a second semifinished fiber-composite product,
arranging the first and the second semifinished fiber-composite product in a foaming mold in such a way that, between the first and the second semifinished fiber-composite product, a cavity is formed, and filling the cavity by a polymeric foam, where
an anchoring structure is arranged in an accommodation space introduced into the first or the second semifinished fiber-composite product in such a way that the anchoring structure protrudes into the cavity and, when foam is introduced into the cavity, is embedded there by the foamed plastic.

33. The process as claimed in claim 32, wherein, during the thermoforming of the first or of the second fiber-composite sheet, a foil made of a thermoplastic is arranged in such a way in a forming mold used during the thermoforming process that, after the thermoforming process, it has bonded coherently to the corresponding semifinished fiber-composite product.

34. The process as claimed in claim 32, wherein a functional element is arranged in such a way in an accommodation space introduced into the first or the second semifinished fiber-composite product that a part of the functional element protrudes into the cavity and, when foam is introduced into the cavity, is embedded there by the foamed plastic.

35. A method comprising utilizing the structural component as claimed in claim 19 for the production of a vehicle bodywork component.

36. The method as claimed in claim 35 wherein the structural component and a force-introducing element are secured at the anchoring structure of the structural component.
